(19) United States
(12) Patent Application Publication
(10) Pub. No.: US 2026/0161323 A1
(43) Pub. Date: Jun. 11, 2026

(54) STORAGE DEVICE FOR PERFORMING PRE ERASE OPERATION AND ELECTRONIC SYSTEM INCLUDING THE STORAGE DEVICE

(71) Applicant: Samsung Electronics Co., Ltd., Suwon-si (KR)

(72) Inventors: Minkyu Kim, Suwon-si (KR); Wookhan Jeong, Suwon-si (KR); Kyoung Back Lee, Suwon-si (KR)

(21) Appl. No.: 19/305,853

(22) Filed: Aug. 21, 2025

(30) Foreign Application Priority Data
Dec. 10, 2024 (KR) 10-2024-0182648

(51) Int. Cl. G06F 3/06

(52) U.S. Cl. CPC G06F 3/0659; G06F 3/0619; G06F 3/064; G06F 3/0679

(57) ABSTRACT

An electronic system includes: a host configured to output a block status analysis command; and a storage device, in response to the block status analysis command, configured to generate a block status information related to the degree of data stored in each of a plurality of memory blocks of a nonvolatile memory device and provide the block status information to the host. The host is further configured to provide the storage device with a pre-erase command instructing a pre-erase operation for invalid memory blocks in which invalid data is stored among the plurality of memory blocks, based on the block status information.

### CROSS-REFERENCE TO RELATED APPLICATION

This application claims priority to and the benefit of Korean Patent Application No. 10-2024-0182648 filed with the Korean Intellectual Property Office on Dec. 10, 2024, the entire contents of which are incorporated herein by reference.

### BACKGROUND

A storage device may include a nonvolatile memory device that stores data and a storage controller that controls the nonvolatile memory device. The storage device can perform a program operation to store write data received from a host into erased memory blocks of the non-volatile memory device. When the storage device receives a request for storing write data but has insufficient erased memory blocks to store the write data, the storage device may perform an erase operation on invalid memory blocks in which invalid data is stored, and then perform a program operation to store the write data in the erased memory blocks and the erased invalid memory blocks.

### SUMMARY

The present disclosure provides storage devices for performing pre erase operation, and electronic systems including the storage devices.

An electronic system according to some implementations of the present disclosure includes a host outputting a block state analysis command and a storage device responsive to the block state analysis command, which generates block state information related to a degree of data stored in each of a plurality of memory blocks of a nonvolatile memory device and provides the block state information to the host. The host provides the storage device with a pre-erase command, which instructs a pre-erase operation for invalid memory blocks storing invalid data among the plurality of memory blocks, based on the block status information.

In some implementations, a method of operating a storage device includes the steps of: receiving a first UPIU (UFS Protocol Information Unit) including an identification number of a pre-erase operation attribute and a first attribute value requesting block status analysis from a host; generating a block status attribute related to erased memory blocks among a plurality of memory blocks of a nonvolatile memory device based on the first attribute value; receiving a second UPIU requesting the block status attribute from the host; providing the block status attribute to the host in response to the second UPIU; receiving a third UPIU including the identification number of the pre-erase operation attribute and the second attribute value requesting a pre-erase operation from the host; and performing the pre-erase operation on invalid memory blocks among the plurality of memory blocks based on the second attribute value.

In some implementations, a method of operating a host includes the steps of providing a storage device with a first UPIU (UFS Protocol Information Unit) including an identification number of a pre-erase operation attribute and a first attribute value requesting block status analysis, providing the storage device with a second UPIU requesting a block status attribute generated according to the first attribute value, receiving the block status attribute from the storage device as a response to the second UPIU, and providing the storage device with a third UPIU including the identification number of the pre-erase operation attribute and a second attribute value requesting a pre-erase operation for invalid memory blocks among a plurality of memory blocks of a nonvolatile memory device based on the block status attribute.

### BRIEF DESCRIPTION OF THE DRAWINGS

FIG. 1 is a diagram illustrating an example of an electronic system including a storage device.

FIG. 2 is a diagram illustrating an example of a storage device that performs an erase operation and a program operation in response to a write command received from a host.

FIG. 3 is a diagram illustrating an example of a storage device that generates block state information and performs a pre-erase operation.

FIG. 4 is a diagram illustrating an example of a storage device that provides information about the sizes of erased memory blocks to a host.

FIG. 5 is a diagram illustrating an example of a storage device that provides information about the ratio of erased memory blocks to a host.

FIG. 6 is a diagram illustrating an example of a storage device that provides information about the size of erased pages to a host.

FIG. 7 is a diagram illustrating an example of a storage device that provides information to a host regarding whether a pre-erase operation is necessary.

FIG. 8 is a diagram illustrating an example of blocks in a storage device that performs a pre-erase operation after performing a garbage collection operation.

FIG. 9 is a diagram illustrating an example of a host providing a UFS Protocol Information Unit (UPIU) including a pre-erase operation attribute to a storage device.

FIG. 10 is a diagram illustrating an example of a host providing a UPIU including a pre-erase operation attribute based on a block state attribute to a storage device.

FIG. 11 is a diagram illustrating an example of a query request UPIU.

FIG. 12 is a diagram for illustration of a query function.

FIG. 13 is a diagram illustrating examples of transaction specific fields of a write property.

FIG. 14 is a diagram illustrating examples of transaction specific fields of a lead attribute.

FIG. 15 is a diagram illustrating an example of pre-erasure operation properties.

FIG. 16 is a diagram illustrating examples of block state properties.

FIG. 17 is a diagram illustrating examples of block state properties.

FIG. 18 is a diagram illustrating an example of pre-erasure size properties.

FIG. 19 is a flowchart illustrating an example of operation of an electronic system.

FIG. 20 is a diagram illustrating an example of a nonvolatile memory device.

FIG. 21 is a diagram illustrating an example of a storage system.

FIG. 22 is a diagram illustrating an example of a UFS (Universal Flash Storage) system.

### DETAILED DESCRIPTION

For clarity of explanation, parts irrelevant to the description may be omitted from drawings and/or description, and the same reference numerals are used for identical or similar components throughout the specification.

Additionally, throughout the specification, whenever a part is said to “include” a component, this does not mean that it excludes other components, but rather that it may include other components, unless otherwise specifically stated.

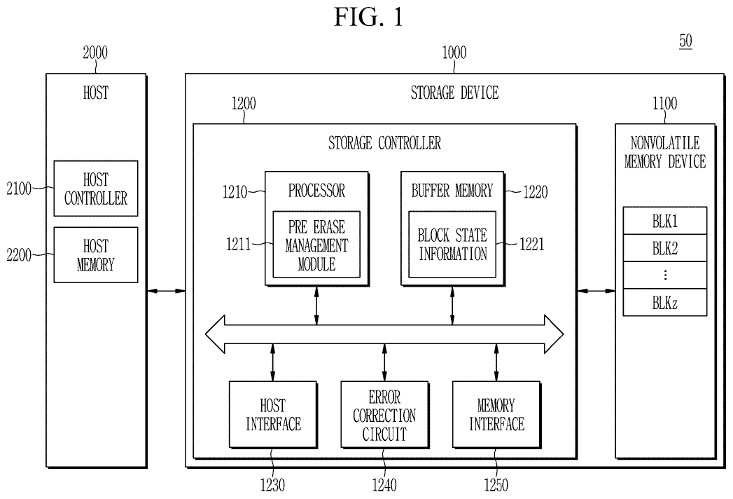

FIG. 1 is a drawing illustrating an example of an electronic system including a storage device. Referring to FIG. 1, an electronic system 50 may include a storage device 1000 and a host 2000.

The storage device 1000 may be a device that stores data under the control of the host 2000. In some implementations, the storage device 1000 may be manufactured in the form of a solid state drive (SSD) or a universal flash storage (UFS).

In some implementations, the storage device 1000 may include a nonvolatile memory device 1100 and a storage controller 1200.

In some implementations, a nonvolatile memory device 1100 can store data. The nonvolatile memory device 1100 can operate in response to the control of the storage controller 1200. In some implementations, the nonvolatile memory device 1100 may be a NAND flash memory. A nonvolatile memory device 1100 may include a plurality of memory blocks (BLK1 to BLKz). Each of the plurality of memory blocks (BLK1 to BLKz) may include a plurality of memory cells that store data. In some implementations, a plurality of memory blocks (BLK1 to BLKz) may include free blocks. In some implementations, the free blocks may include erased memory blocks and invalid memory blocks. In some implementations, the erased memory blocks may be memory blocks that do not have data stored on them. In some implementations, memory cells included in the erased memory blocks may be memory cells in an erased state. In some implementations, the invalid memory blocks may be memory blocks in which invalid data is stored.

In some implementations, a plurality of memory blocks (BLK1 to BLKz) may include valid memory blocks. In some implementations, the valid memory blocks may be memory blocks in which valid data is stored. In some implementations, a plurality of memory blocks (BLK1 to BLKz) may include open blocks. In some implementations, an open block may be a memory block in which some data is stored. In some implementations, an open block may include programmed pages and erased pages.

In some implementations, a nonvolatile memory device 1100 may receive a command and an address from a storage controller 1200 and perform an operation indicated by the command for an area selected by the address. A nonvolatile memory device 1100 can perform a program operation (write operation) to store data in an area selected by an address, a read operation to read data, or an erase operation to delete data.

The storage controller 1200 can control the overall operation of the storage device 1000.

In some implementations, the storage controller 1200 can execute firmware when power is applied to the storage device 1000. The firmware may include a host interface layer that controls communication with the host 2000, a flash translation layer that controls communication between the host 2000 and the nonvolatile memory device 1100, and a memory interface layer that controls communication with the nonvolatile memory device 1100. In some implementations, the flash translation layer may translate a logical address of a host 2000 into a physical address of a nonvolatile memory device 1100.

In some implementations, the storage controller 1200 may control the nonvolatile memory device 1100 to perform a write operation, a read operation, or an erase operation according to a command from the host 2000. The storage controller 1200 can provide a write command, address, and data to the nonvolatile memory device 1100 during a write operation. The storage controller 1200 can provide a read command and address to the nonvolatile memory device 1100 during a read operation. The storage controller 1200 can provide an erase command and address to the nonvolatile memory device 1100 during an erase operation.

In some implementations, the storage controller 1200 may include a processor 1210, a buffer memory 1220, a host interface 1230, an error correction circuit 1240, and a memory interface 1250.

In some implementations, the processor 1210 may control the overall operation of the storage controller 1200. The processor 1210 can control a program operation according to a write command of the host 2000 and a read operation according to a read command of the host 2000.

In some implementations, the processor 1210 may include a pre-erasure management module 1211. In some implementations, the pre-erase management module 1211 may control the nonvolatile memory device 1100 to perform a pre-erase operation for pre-erase of invalid data stored in invalid memory blocks among a plurality of memory blocks (BLK1 to BLKz) of the nonvolatile memory device 1100.

In some implementations, the pre-erase management module 1211 may receive a block state analysis command from the host 2000 and, in response to the block state analysis command, perform a block state analysis operation to generate block state information 1221 related to the degree of data stored in each of a plurality of memory blocks (BLK1 to BLKz). In some implementations, the pre-erase management module 1211 may generate information related to erased memory blocks among a plurality of memory blocks (BLK1 to BLKz), information related to invalid memory blocks, information related to open blocks, or information regarding whether a pre-erase operation is necessary as block status information 1221. For example, the block state information 1221 can be based on an erased state of data units in at least one memory block of the plurality of memory blocks (BLK1 to BLKz). The erased state can be, for example, whether a data unit is erased. The data units can be, for example, blocks of the plurality of memory blocks (BLK1 to BLKz) or pages of a plurality of pages of a memory block, e.g., as discussed in reference to erased page size information (PG_ERS_SIZE) below. Each of the information related to erased memory blocks among a plurality of memory blocks (BLK1 to BLKz), information related to invalid memory blocks, information related to open blocks, and information regarding whether a pre-erase operation is necessary, as block status information 1221, is an example of block state information 1221 that is based on an erased state of data units in at least one memory block of the plurality of memory blocks (BLK1 to BLKz).

In some implementations, the pre-erase management module 1211 may provide block status information 1221 to the host 2000 in response to a block status analysis command.

In some implementations, the pre-erase management module 1211 may provide block status information 1221 to the host 2000, and then control the nonvolatile memory device 1100 to perform a pre-erase operation on invalid memory blocks among a plurality of memory blocks (BLK1 to BLKz) in response to a pre-erase command received from the host 2000.

In some implementations, the buffer memory 1220 may be used as a cache memory or an operating memory of the storage controller 1200.

In some implementations, the buffer memory 1220 may temporarily store data provided from the host 2000 or temporarily store data read from a nonvolatile memory device 1100. In some implementations, the buffer memory 1220 may be a dynamic random access memory (DRAM) or a static random access memory (SRAM). In some implementations, the buffer memory 1220 may be located within the storage controller 1200 or may be located outside the storage controller 1200.

In some implementations, the buffer memory 1220 can store block status information 1221. In some implementations, the block status information 1221 may include information about the size or number of erased memory blocks among a plurality of memory blocks (BLK1 to BLKz). In some implementations, the size of the erased memory blocks may correspond to the size of data that can be stored in the erased memory blocks.

In some implementations, the block status information 1221 may include information about the ratio of erased memory blocks among free blocks. In some implementations, the block status information 1221 may include information about the size of erased pages included in an open block among a plurality of memory blocks (BLK1 to BLKz). In some implementations, the block state information 1221 may include information regarding whether a pre-erase operation is necessary.

In some implementations, the host interface 1230 can communicate with the host 2000. The host interface 1230 can receive commands or data from the host 2000, or provide a response or data to a command to the host 2000.

In some implementations, the error correction circuit 1240 may perform an encoding operation to generate parity data for data received from the host 2000. The encoded data can be provided to a non-volatile memory device 1100 via a memory interface 1250. An error correction circuit 1240 can perform an error correction operation on data read from a nonvolatile memory device 1100. An error correction circuit 1240 can perform an error correction operation to correct error bits included in data read from a nonvolatile memory device 1100. The error correction circuit 1350 can provide error-corrected data to the host 2000 through the host interface 1230.

In some implementations, the memory interface 1250 may communicate with a nonvolatile memory device 1100. The memory interface 1250 can provide commands or data to the nonvolatile memory device 1100, or receive data from the nonvolatile memory device 1100.

In some implementations, the host 2000 may include a host controller 2100 and host memory 2200.

In some implementations, the host controller 2100 can control the overall operation of the host 2000. In some implementations, the host controller 2100 may generate a write command requesting to store data in the storage device 1000 and a read command requesting data stored in the storage device 1000.

In some implementations, the host controller 2100 may provide a block status analysis command requesting status analysis of a plurality of memory blocks (BLK1 to BLKz) of a nonvolatile memory device 1100 to the storage device 1000. In some implementations, the host controller 2100 may provide a pre-erase command to the storage device 1000 to instruct pre-erase invalid data stored in invalid memory blocks among a plurality of memory blocks (BLK1 to BLKz).

In some implementations, host memory 2200 can store data. In some implementations, the host memory 2200 may be volatile memory.

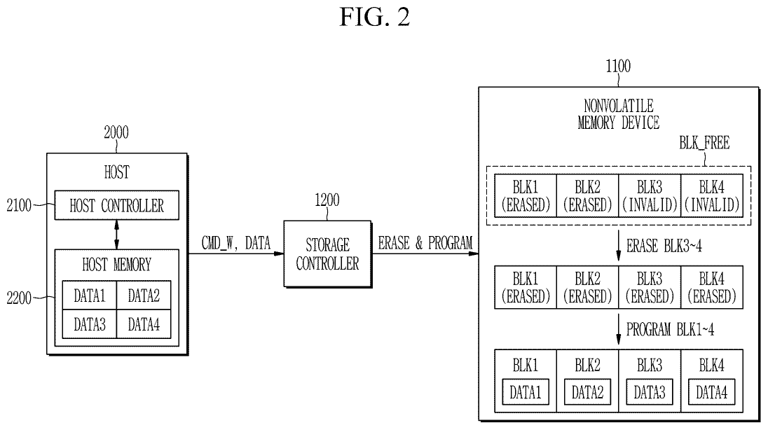

FIG. 2 is a diagram illustrating an example of a storage device that performs an erase operation and a program operation in response to a write command received from a host.

Referring to FIG. 2, the host memory 2200 included in the host 2000 can store first data (DATA1), second data (DATA2), third data (DATA3), and fourth data (DATA4). In some implementations, the nonvolatile memory device 1100 may include free blocks (BLK_FREE). Free blocks (BLK_FREE) may contain erased memory blocks (ERASED) and invalid memory blocks (INVALID). In some implementations, the first memory block (BLK1) and the second memory block (BLK2) may be erased memory blocks (ERASED), and the third memory block (BLK3) and the fourth memory block (BLK4) may be invalid memory blocks (INVALID).

In some implementations, the host controller 2100 may provide a write command (CMD_W) and first to fourth data (DATA1 to DATA4) to the storage controller 1200. In some implementations, the storage controller 1200 may control the nonvolatile memory device 1100 to store first to fourth data (DATA1 to DATA4) in the nonvolatile memory device 1100 in response to a write command (CMD_W). However, if the size of the first to fourth data (DATA1 to DATA4) is greater than the size of the erased memory blocks (ERASED), the storage controller 1200 may control the nonvolatile memory device 1100 to perform an erase operation to erase invalid data stored in invalid memory blocks (INVALID) among the plurality of memory blocks, and then perform a program operation to store data in the erased invalid memory blocks.

In some implementations, the storage controller 1200 may control the nonvolatile memory device 1100 to perform an erase operation on the third memory block (BLK3) and the fourth memory block (BLK4) corresponding to the invalid memory blocks (INVALID) if the size of the first to fourth data (DATA1 to DATA4) is greater than the size of the first memory block (BLK1) and the second memory block (BLK2) corresponding to the erased memory blocks (ERASED), and to perform a program operation to store the first to fourth data (DATA1 to DATA4) in the first to fourth memory blocks (BLK1 to BLK4).

In some implementations, if the size of data received from the host 2000 is larger than the size of erased memory blocks (ERASED), the storage device 1000 must perform an erase operation on invalid memory blocks (INVALID) before performing a program operation, so the timing of performing the program operation may be delayed.

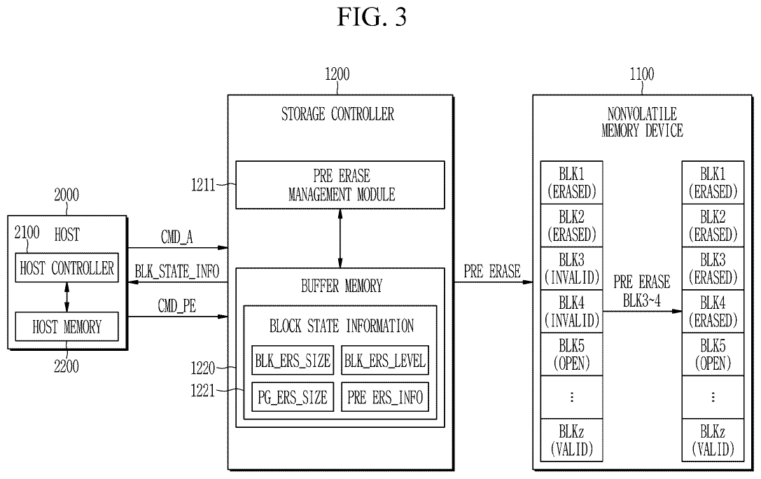

FIG. 3 is a diagram illustrating an example of a storage device that generates block state information and performs a pre-erase operation.

Referring to FIG. 3, the host controller 2100 may provide a block status analysis command (CMD_A) to the storage controller 1200 when the storage device 1000 is in an idle state. In some implementations, the idle state may be a state in which the storage device 1000 is not performing any operation. In some implementations, the block status analysis command (CMD_A) may be a command that requests information related to the degree to which data is stored in each of a plurality of memory blocks (BLK1 to BLKz) of the nonvolatile memory device 1100.

In some implementations, the storage controller 1200 may perform a block state analysis operation to generate block state information 1221 related to the degree of data stored in each of a plurality of memory blocks (BLK1 to BLKz) in response to a block state analysis command (CMD_A). In some implementations, the storage controller 1200 may provide block status information 1221 to the host 2000 in response to a block status analysis command (CMD_A).

In some implementations, the pre-erasure management module 1211 may generate erase block size information (BLK_ERS_SIZE) regarding the size of erased memory blocks (ERASED) among a plurality of memory blocks (BLK1 to BLKz) as block status information 1221.

In some implementations, the pre-erasure management module 1211 may generate erase block level information (BLK_ERS_LEVEL) regarding the ratio of erased memory blocks (ERASED) among free blocks including erased memory blocks (ERASED) and invalid memory blocks (INVALID) as block status information 1221.

In some implementations, the pre-erase management module 1211 may generate erased page size information (PG_ERS_SIZE) regarding the sizes of erased pages of an open block (OPEN) among a plurality of memory blocks (BLK1 to BLKz) as block status information 1221.

In some implementations, the pre-erase management module 1211 may generate pre-erase necessity information (PRE ERS_INFO) regarding the necessity of a pre-erase operation as block status information 1221 based on the size of erased memory blocks (ERASED) among a plurality of memory blocks (BLK1 to BLKz). The pre-erase necessity information (PRE ERS_INFO) can indicate to the host controller 2100 whether the host controller 2100 should instruct a pre-erase operation.

In some implementations, the host controller 2100 may generate a pre-erase command (CMD_PE) based on block status information 1221 received from the storage controller 1200 and provide the pre-erase command (CMD_PE) to the storage controller 1200.

In some implementations, the storage controller 1200 may control the nonvolatile memory device 1100 to perform a pre-erase operation to erase invalid data stored in invalid memory blocks (INVALID) among a plurality of memory blocks (BLK1 to BLKz) in response to a pre-erase command (CMD_PE). In some implementations, the storage controller 1200 may control the nonvolatile memory device 1100 to perform a pre-erase operation on the third memory block (BLK3) and the fourth memory block (BLK4) corresponding to the invalid memory blocks (INVALID) in response to the pre-erase command (CMD_PE). In some implementations, when invalid data stored in the third memory block (BLK3) and the fourth memory block (BLK4) are erased by a pre-erase operation, the third memory block (BLK3) and the fourth memory block (BLK4) can correspond to erased memory blocks (ERASE).

In some implementations, the storage device 1000 may generate block status information 1221 in response to a block status analysis command (CMD_A) received from the host 2000 and provide the block status information 1221 to the host 2000. In some implementations, the storage device 1000 performs a pre-erase operation on invalid memory blocks (ERASE) in response to a pre-erase command (CMD_A) received from the host 2000, so that even if a write command is received from the host 2000, the storage device can perform a program operation on the pre-erased invalid memory blocks without performing an erase operation on the invalid memory blocks (INVALID).

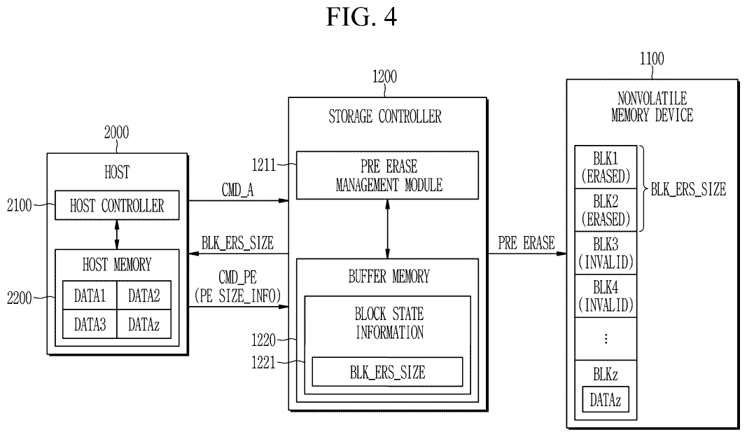

FIG. 4 is a diagram illustrating an example of a storage device that provides information about the sizes of erased memory blocks to a host.

Referring to FIG. 4, the host controller 2100 can provide a block status analysis command (CMD_A) to the storage controller 1200. In some implementations, the pre-erasure management module 1211 may generate block state information 1221 in response to a block state analysis command (CMD_A).

In some implementations, the pre-erase management module 1211 may generate erase block size information (BLK_ERS_SIZE) regarding the sizes of erased memory blocks among a plurality of memory blocks (BLK1 to BLKz) as block status information 1221 and provide the erase block size information (BLK_ERS_SIZE) to the host.

In some implementations, the host controller 2100 may provide a pre-erase command (CMD_PE) to the storage controller 1200 based on erase block size information (BLK_ERS_SIZE). In some implementations, the host controller 2100 may provide a pre-erase command (CMD_PE) to the storage controller 1200 based on the result of comparing the size of erased memory blocks with the threshold size.

In some implementations, the host controller 2100 may provide a pre-erase command (CMD_PE) to the storage controller 1200 if the size of the erased memory blocks is less than a threshold size. In some implementations, the host controller 2100 may not provide a pre-erase command (CMD_PE) to the storage controller 1200 if the size of the erased memory blocks is greater than a threshold size.

In some implementations, the sizes of the erased memory blocks may correspond to the sizes of the first memory block (BLK1) and the second memory block (BLK2).

In some implementations, the threshold size may correspond to (e.g., may be, or may be based on) the size of data to be provided to the storage controller 1200 among the data stored in the host memory 2200. In some implementations, data to be provided to the storage controller 1200 among data stored in the host memory 2200 may be data that is not stored in the non-volatile memory device 1100 among data stored in the host memory 2200. In some implementations, among the first to third data (DATA1 to DATA3) and the z-th data (DATAz) stored in the host memory 2200, the first to third data (DATA1 to DATA3) that are not stored in the non-volatile memory device 1100 may be stored. In some implementations, data to be provided to the storage controller 1200 among data stored in the host memory 2200 may be data to be stored in the nonvolatile memory device 1100 according to a write command of the host 2000. For example, the data to be provided to the storage controller 1200 can be assigned for storage in the nonvolatile memory device 1100.

In some implementations, data stored in the host memory 2200 that will not be provided to the storage controller 1200 may be data stored in a non-volatile memory device 1100. In some implementations, among the first to third data (DATA1 to DATA3) and the z-th data (DATAz) stored in the host memory 1100, the data stored in the nonvolatile memory device 1100 may be the z-th data (DATAz) stored in the z-th memory block (BLKz). In some implementations, the host controller 1200 may provide a pre-erase command (CMD_PE) to the storage controller 1200 if the sizes of the first memory block (BLK1) and the second memory block (BLK2) are smaller than the sizes of the first to third data (DATA1 to DATA3).

In some implementations, the pre-erase management module 1211 may control the nonvolatile memory device 1100 to perform a pre-erase operation on invalid memory blocks (INVALID) among a plurality of memory blocks (BLK1 to BLKz) in response to a pre-erase command (CMD_PE). In some implementations, the target of the pre-erase operation may be some or all of the invalid memory blocks (INVALID).

In some implementations, the host controller 2100 may determine the size of memory blocks to be pre-erased based on the sizes of erased memory blocks, and provide a pre-erasing command (CMD_PE) including pre-erasing size information (PE SIZE_INFO) regarding the sizes of memory blocks to be pre-erased to the storage controller 1200.

In some implementations, the host controller 2100 may determine the size of a memory block to be pre-erased based on the difference between the size of erased memory blocks and the size of data to be provided to the storage controller 1200 among data stored in the host memory 2200. In some implementations, the host controller 2100 may determine the size of a memory block to be pre-erased as the size of one memory block based on the difference in the sizes of the first memory block (BLK1) and the second memory block (BLK2) and the first to third data (DATA1 to DATA3).

In some implementations, the pre-erase management module 1211 may control the nonvolatile memory device 1100 to perform a pre-erase operation on invalid memory blocks corresponding to the size of a memory block to be pre-erase among invalid memory blocks (INVALID) based on pre-erase size information (PE SIZE_INFO) included in the pre-erase command (CMD_PE). In some implementations, the pre-erase management module 1211 may control the nonvolatile memory device 1100 to perform a pre-erase operation on one of the third memory block (BLK3) and the fourth memory block (BLK4) based on pre-erase size information (PE SIZE_INFO) corresponding to one size included in the pre-erase command (CMD_PE).

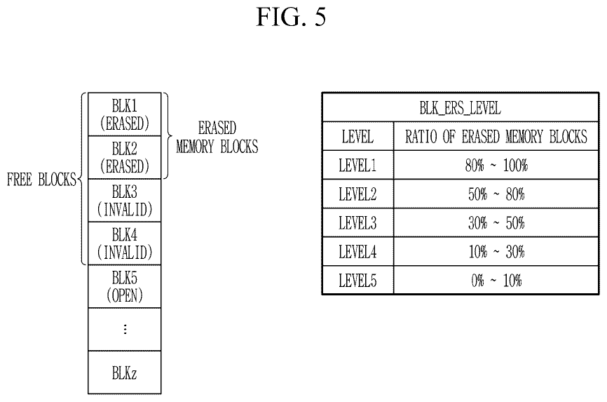

FIG. 5 is a diagram illustrating an example of a storage device that provides information about the ratio of erased memory blocks to a host. FIG. 5 provides further illustration of operations described with respect to FIGS. 3 and 4. Referring to FIG. 5, the pre-erase management module 1211 may generate erase block level information (BLK_ERS_LEVEL) regarding the ratio of erased memory blocks (ERASED) among free blocks (FREE BLOCKS) as block status information 1221 in response to a block status analysis command (CMD_A) received from the host 2000, and provide the erase block level information (BLK_ERS_LEVEL) to the host 2000.

In some implementations, the ratio of erased memory blocks (ERASED) may be the size of erased memory blocks (ERASED) to the sum of the sizes of erased memory blocks (ERASED) and invalid memory blocks (INVALID).

In some implementations, the pre-erase management module 1211 may provide erase block level information (BLK_ERS_LEVEL) indicating that the ratio (or proportion) of erased memory blocks (ERASED) among free blocks (FREE BLOCKS) exceeds 80% and is less than or equal to 100% to the host 2000 that the ratio of erased memory blocks (ERASED) is at the first level (LEVEL1).

In some implementations, the pre-erase management module 1211 may provide erase block level information (BLK_ERS_LEVEL) indicating that the ratio of erased memory blocks (ERASED) among free blocks (FREE BLOCKS) exceeds 50% and is less than or equal to 80% to the host 2000 that the ratio of erased memory blocks (ERASED) Is at the Second Level (LEVEL2).

In some implementations, the pre-erase management module 1211 may provide erase block level information (BLK_ERS_LEVEL) indicating that the ratio of erased memory blocks (ERASED) among free blocks (FREE BLOCKS) exceeds 30% and is less than or equal to 50% to the host 2000 that the ratio of erased memory blocks (ERASED) is at the third level (LEVEL3).

In some implementations, the pre-erase management module 1211 may provide erase block level information (BLK_ERS_LEVEL) indicating that the ratio of erased memory blocks (ERASED) among free blocks (FREE BLOCKS) exceeds 10% and is less than or equal to 30% to the host 2000 that the ratio of erased memory blocks (ERASED) is at the fourth level (LEVEL4).

In some implementations, the pre-erase management module 1211 may provide the host 2000 with erased block level information (BLK_ERS_LEVEL) indicating that the ratio of erased memory blocks (ERASED) among free blocks (FREE BLOCKS) is at the fifth level (LEVEL5) if the ratio is 0% or more and 10% or less.

In some implementations, the higher the level (LEVEL) included in the erase block level information (BLK_ERS_LEVEL), the lower the ratio of erased memory blocks (ERASED). In some implementations, the higher the level (LEVEL) included in the erase block level information (BLK_ERS_LEVEL), the higher the need for a pre-erase operation to be performed.

In some implementations, the host controller 2100 may provide a pre-erase command (CMD_PE) to the storage controller 1200 based on a result of comparing the level (LEVEL) included in the erase block level information (BLK_ERS_LEVEL) received from the storage controller 1200 with the first threshold level. In some implementations, the host controller 2100 may provide a pre-erase command (CMD_PE) to the storage controller 1200 if the level (LEVEL) included in the erase block level information (BLK_ERS_LEVEL) is higher than the first threshold level. In some implementations, the host controller 2100 may provide a pre-erase command (CMD_PE) to the storage controller 1200 if the erase block level information (BLK_ERS_LEVEL) includes the fourth level (LEVEL4) or the fifth level (LEVEL5).

In some implementations, the host controller 2100 may not provide a pre-erase command (CMD_PE) to the storage controller 1200 if the level (LEVEL) included in the erase block level information (BLK_ERS_LEVEL) is equal to or lower than the first threshold level. In some implementations, the host controller 2100 may not provide a pre-erase command (CMD_PE) to the storage controller 1200 if the erase block level information (BLK_ERS_LEVEL) includes the first level (LEVEL1), the second level (LEVEL2), or the third level (LEVEL3).

In some implementations, the host controller 2100 may determine the size of memory blocks to be pre-erased based on erase block level information (BLK_ERS_LEVEL) and provide a pre-erasing command (CMD_PE) including pre-erasing size information (PE SIZE_INFO) regarding the size of memory blocks to be pre-erased to the storage controller 1200.

In some implementations, the host controller 2100 may determine the size of memory blocks to be pre-erased based on a result of comparing the level (LEVEL) included in the erase block level information (BLK_ERS_LEVEL) with the second threshold level. In some implementations, the host controller 2100 may determine the size of memory blocks to be pre-erased as the first size if the erase block level information (BLK_ERS_LEVEL) includes the fourth level (LEVEL4). In some implementations, the host controller 2100 may determine the size of memory blocks to be pre-erased as a second size larger than the first size if the erase block level information (BLK_ERS_LEVEL) includes the fifth level (LEVEL5). For example, when the ratio of erased memory blocks is lower, the size of memory blocks to be pre-erased may be higher.

In some implementations, the pre-erase management module 1211 may control the nonvolatile memory device 1100 to perform a pre-erase operation on invalid memory blocks (INVALID) in response to a pre-erase command (CMD_PE). In some implementations, the pre-erase management module 1211 may control the nonvolatile memory device 1100 to perform a pre-erase operation on invalid memory blocks (INVALID) corresponding to the size of memory blocks to be pre-erase based on pre-erase size information (PE SIZE_INFO).

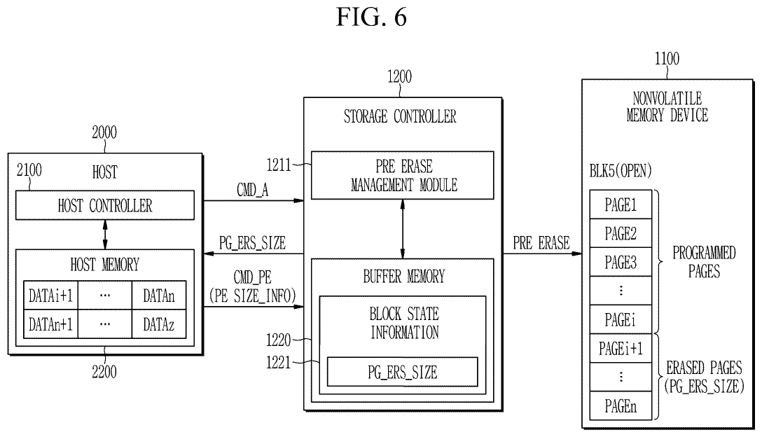

FIG. 6 is a diagram illustrating an example of a storage device that provides information about the size of erased pages to a host.

Referring to FIG. 6, the pre-erase management module 1211 may generate erased page size information (PG_ERS_SIZE) regarding the sizes of erased pages (ERASED PAGES) among a plurality of pages (PAGE1 to PAGEn) included in an open block (OPEN) as block status information 1221 in response to a block status analysis command (CMD_A) received from the host 2000, and provide the erased page size information (PG_ERS_SIZE) to the host 2000. In some implementations, an open block (OPEN) may be a memory block in which some data is stored. In some implementations, an open block (OPEN) may be a memory block that will be the target of a program operation when a write command is received from the host 2000.

In some implementations, a plurality of pages (PAGE1 to PAGEn) included in an open block (OPEN) may include programmed pages (PROGRAMMED PAGES) and erased pages (ERASED PAGES). In some implementations, PROGRAMMED PAGES may be pages on which program operations are performed. In some implementations, the programmed pages (PROGRAMMED PAGES) may be the first to i-th pages (PAGE1 to PAGEi).

In some implementations, ERASED PAGES may be pages on which no program operation has been performed. In some implementations, ERASED PAGES may include memory cells in an erased state. In some implementations, the erased pages (ERASED PAGES) may be the i-th to n-th pages (PAGEi PAGEn). In some implementations, the size of the erased pages (ERASED PAGES) may correspond to the size of the i-th to n-th pages (PAGEi PAGEn).

In some implementations, the host controller 2100 may receive erase page size information (PG_ERS_SIZE) from the storage controller 1200, and provide a pre-erase command (CMD_PE) to the storage controller 1200 based on a result of comparing the size of erased pages (ERASED PAGES) included in the erase page size information (PG_ERS_SIZE) with data stored in the host 2000.

In some implementations, the host controller 2100 may provide a pre-erase command (CMD_PE) to the storage controller 1200 if the size of data to be provided to the storage controller 1200 among the data stored in the host memory 2200 is larger than the size of erased pages (ERASED PAGES). In some implementations, data to be provided to the storage controller 1200 among data stored in the host memory 2200 may be data that is not stored in the non-volatile memory device 1100 among data stored in the host memory 2200.

In some implementations, if the data to be provided to the storage controller 1200 among the i-th to z-th data (DATAi 1 to DATAz) stored in the host memory 2200 are the i-th to n-th data (DATAi 1 to DATAn 1), and the size of the i-th to n-th data (DATAi 1 to DATAn 1) is larger than the size of the i-th to n-th pages (PAGEi 1 to PAGEn) corresponding to the size of erased pages (ERASED PAGES), the host controller 2100 may provide a pre-erase command (CMD_PE) to the storage controller 1200.

In some implementations, the host controller 2100 may not provide a pre-erase command (CMD_PE) to the storage controller 1200 if the size of data to be provided to the storage controller 1200 among the data stored in the host memory 2200 is smaller than the size of erased pages (ERASED PAGES).

In some implementations, the host controller 2100 may not provide a pre-erase command (CMD_PE) to the storage controller 1200 if the size of the i-th to n-th data (DATAi 1 to DATAn 1) to be provided to the storage controller 1200 among the i-th to z-th data (DATAi 1 to DATAz) stored in the host memory 2200 is smaller than the size of the i-th to n-th pages (PAGEi 1 to PAGEn).

In some implementations, the host controller 2100 may determine the size of memory blocks to be pre-erased based on the difference in the size of erased pages (ERASED PAGES) and the size of data to be provided to the storage controller 1200 among data stored in the host memory 2200. In some implementations, the host controller 2100 may determine the sizes of memory blocks to be pre-erased based on the difference between the sizes of the i-th to n-th data (DATAi 1 to DATAn 1) to be provided to the storage controller 1200 among the i-th to z-th data (DATAi 1 to DATAz) stored in the host memory 2200 and the sizes of the i-th to n-th pages (PAGEi 1 to PAGEn).

In some implementations, the host controller 2100 may provide a pre-erase command (CMD_PE) including pre-erase size information (PE SIZE_INFO) regarding the size of memory blocks to be pre-erase to the storage controller 1200.

In some implementations, the pre-erase management module 1211 may control the nonvolatile memory device 1100 to perform a pre-erase operation on invalid memory blocks (INVALID) in response to a pre-erase command (CMD_PE). In some implementations, the pre-erase management module 1211 may control the nonvolatile memory device 1100 to perform a pre-erase operation on invalid memory blocks (INVALID) corresponding to the size of memory blocks to be pre-erase based on pre-erase size information (PE SIZE_INFO).

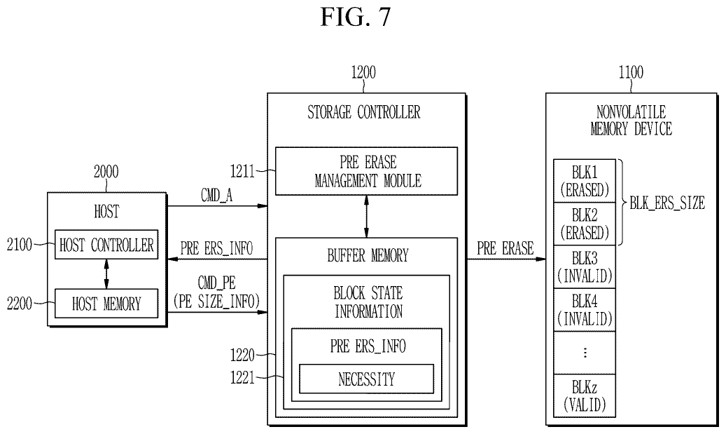

FIG. 7 is a diagram illustrating an example of a storage device that provides information to a host regarding whether a pre-erase operation is necessary.

Referring to FIG. 7, the pre-erase management module 1211 may generate pre-erase necessity information (PRE ERS_INFO) regarding whether a pre-erase operation is necessary (or should be performed, or is recommended) as block status information 1221 in response to a block status analysis command (CMD_A) received from the host 2000, and provide the pre-erase necessity information (PRE ERS_INFO) to the host 2000.

In some implementations, the pre-erase management module 1211 may generate pre-erase requirement information (PRE ERS_INFO) based on the size (BLK_ERS_SIZE) of erased memory blocks among a plurality of memory blocks (BLK1 to BLKz). In some implementations, the pre-erase management module 1211 may generate pre-erase necessity information (PRE ERS_INFO) indicating that a pre-erase operation is necessary (NECESSITY) if the size of erased memory blocks (BLK_ERS_SIZE) is smaller than a threshold size.

In some implementations, the pre-erase management module 1211 may generate pre-erase required information (PRE ERS_INFO) indicating that a pre-erase operation is unnecessary if the size of erased memory blocks (BLK_ERS_SIZE) is greater than a threshold size.

In some implementations, the host controller 2100 may provide a pre-erase command (CMD_PE) to the storage controller 1200 based on pre-erase required information (PRE ERS_INFO).

In some implementations, the host controller 2100 may provide a pre-erase command (CMD_PE) to the storage controller 1200 when it receives pre-erase need information (PRE ERS_INFO) indicating that a pre-erase operation is required (NECESSITY) from the storage controller 1200. In some implementations, when the host controller 2100 receives pre-erase requirement information (PRE ERS_INFO) indicating that a pre-erase operation is required (NECESSITY), the host controller 2100 may determine the sizes of memory blocks to be pre-erased based on the sizes of data to be provided to the storage controller 1200 among data stored in the host memory 2200, and provide a pre-erase command (CMD_PE) including pre-erase size information (PE SIZE_INFO) to the storage controller 1200.

In some implementations, the host controller 2100 may not provide a pre-erase command (CMD_PE) to the storage controller 1200 when it receives pre-erase required information (PRE ERS_INFO) from the storage controller 1200 indicating that a pre-erase operation is unnecessary.

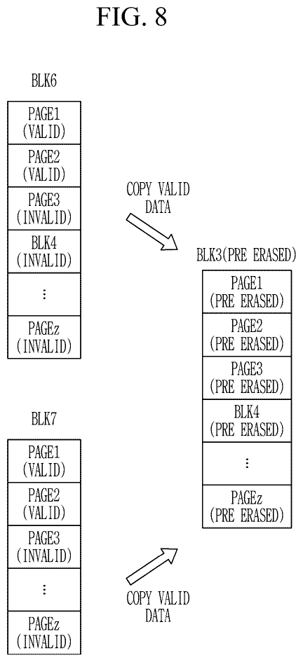

FIG. 8 is a diagram for explaining an example of a storage device that performs a pre-erase operation after performing a garbage collection operation.

Referring to FIG. 8, the storage device 1000 can perform a pre-erase operation on an invalid memory block among a plurality of memory blocks in response to a pre-erase command received from the host 2000. In some implementations, the storage device 1000 can pre-erase invalid data stored in a third memory block (BLK3) corresponding to an invalid memory block while performing a pre-erase operation. In some implementations, after a pre-erase operation is performed on the third memory block (BLK3), the third memory block (BLK3) can correspond to the pre-erase memory block.

In some implementations, the sixth memory block (BLK6) and the seventh memory block (BLK7) may each include multiple pages. In some implementations, data stored in the first page (PAGE1) and the second page (PAGE2) of the sixth memory block (BLK6) may be valid data (VALID). In some implementations, data stored in the third to zth pages (PAGE3 to PAGEz) of the sixth memory block (BLK6) may be invalid data (INVALID).

In some implementations, data stored in the first page (PAGE1) and the second page (PAGE2) of the seventh memory block (BLK7) may be valid data (VALID). In some implementations, data stored in the third to zth pages (PAGE3 to PAGEz) of the seventh memory block (BLK7) may be invalid data (INVALID).

In some implementations, the storage device 1000 may perform a garbage collection operation of copying valid data stored in valid pages among a plurality of pages each included in a plurality of memory blocks to a pre-erased memory block.

In some implementations, the storage device 1000 may copy valid data (VALID) stored in the first page (PAGE1) and the second page (PAGE2) of the sixth memory block (BLK6) and valid data (VALID) stored in the first page (PAGE1) and the second page (PAGE2) of the seventh memory block (BLK7) to the first to fourth pages (PAGE1 to PAGE4) of the third memory block (BLK3) while performing a garbage collection operation.

In some implementations, since the storage device 1000 has pre-erased invalid data stored in the third memory block (BLK3) according to the pre-erasing command of the host 2000, valid data can be copied to the pre-erased third memory block (BLK3) without performing an erasing operation on the third memory block (BLK3) while performing a garbage collection operation. For example, the pre-erasing can be performed prior to the garbage collection operation.

In some implementations, the storage device 1000 may perform a garbage collection operation to copy valid data stored in the sixth memory block (BLK6) and the seventh memory block (BLK7) to the third memory block (BLK3), and then set the sixth memory block (BLK6) and the seventh memory block (BLK7) as invalid memory blocks. In some implementations, the storage device 1000 may perform a pre-erase operation on the sixth memory block (BLK6) and the seventh memory block (BLK7) in response to a pre-erase command received from the host 2000 during idle time. Invalid data stored in the sixth memory block (BLK6) and the seventh memory block (BLK7) can be pre-erased according to the pre-erasing operation.

In some implementations, the storage device 1000 may perform a HID (Host Initiated Defragmentation) operation to copy valid data stored in the sixth memory block (BLK6) and the seventh memory block (BLK7) to the third memory block (BLK3) in response to a HID command of the host 2000 according to the UFS standard so that the valid data stored in the sixth memory block (BLK6) and the seventh memory block (BLK7) are aligned with data corresponding to consecutive logical addresses.

Since the storage device 1000 has pre-erased invalid data stored in the third memory block (BLK3) according to the pre-erasing command of the host 2000, the storage device can copy valid data to the pre-erased third memory block (BLK3) in the order of consecutive logical addresses without performing an erase operation on the third memory block (BLK3) while performing the HID operation. For example, the pre-erasing can be performed prior to the HID operation.

In some implementations, the storage device 1000 may perform an HID operation to copy valid data stored in the sixth memory block (BLK6) and the seventh memory block (BLK7) to the third memory block (BLK3) in the order of logical addresses, and then perform a pre-erase operation on the sixth memory block (BLK6) and the seventh memory block (BLK7) set as invalid memory blocks according to a pre-erase command of the host 2000.

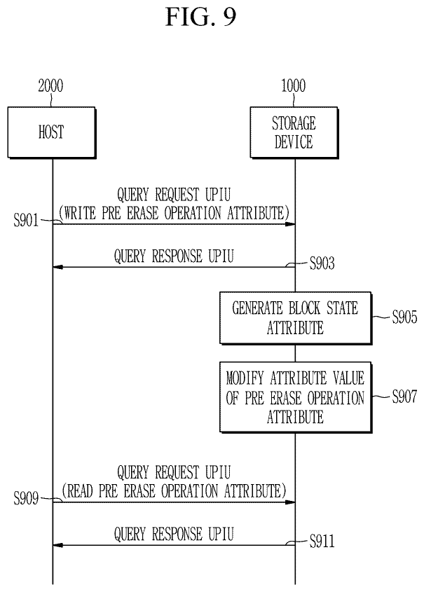

FIG. 9 is a diagram illustrating an example of a host providing a UFS Protocol Information Unit (UPIU) including a pre-erase operation attribute to a storage device.

Referring to FIG. 9, the host 2000 and the storage device 1000 can perform any of the operations described with reference to FIGS. 1 to 8 according to the UFS (Universal Flash Storage) standard.

In some implementations, in S901, the host 2000 may provide a query request UPIU (UFS Protocol Information Unit) requesting a write of a pre-erase operation attribute requesting performance of a block state analysis operation to the storage device 1000. In some implementations, the pre-erase operation attribute may include an identification number of the pre-erase operation attribute and a first attribute value requesting a block state analysis operation. In some implementations, a query request UPIU requesting a block state analysis operation may correspond to a block state analysis command (CMD_A) described with reference to FIGS. 1 to 8.

In some implementations, in S903, the storage device 1000 may store a pre-erase operation attribute including a first attribute value requesting a block state analysis operation in response to a query request UPIU, and provide a query response UPIU indicating that the pre-erase operation attribute has been stored to the host 2000. In some implementations, the host 2000 can identify that a pre-erase operation attribute is stored in the storage device based on the query response UPIU.

In some implementations, at S905, the storage device 1000 may perform a block state analysis operation to generate a block state attribute in response to a query request UPIU requesting a block state analysis operation. In some implementations, the block state attribute may correspond to the block state information 1221 described with reference to FIGS. 1 to 8.

In some implementations, the storage device 1000 may generate erased block size information (BLK_ERS_SIZE) regarding the sizes of erased memory blocks among a plurality of memory blocks as a block status attribute. In some implementations, the storage device 1000 may generate erased block level information (BLK_ERS_LEVEL) regarding the ratio of erased memory blocks among free blocks as a block status attribute. In some implementations, the storage device 1000 may generate erased page size information (PG_ERS_SIZE) regarding the sizes of erased pages of an open block among a plurality of memory blocks as a block status attribute. In some implementations, the storage device 1000 may generate pre-erase need information (PRE ERS_INFO) regarding whether a pre-erase operation is needed as a block status attribute.

In some implementations, in S907, the storage device 1000 may generate a block status attribute, and then modify an attribute value included in a pre-erase operation attribute from a first attribute value to a second attribute value corresponding to completion of a block status analysis operation.

In some implementations, at S909, the host 2000 may provide a query request UPIU requesting a read of a pre-erase operation attribute to the storage device 1000.

In some implementations, in S911, the storage device 1000 may provide, to the host 2000, a query response UPIU including a pre-erase operation attribute of a second attribute value corresponding to completion of a block state analysis operation in response to the query request UPIU. In some implementations, the host 2000 can identify that the block status analysis operation is completed based on the second attribute value included in the query response UPIU.

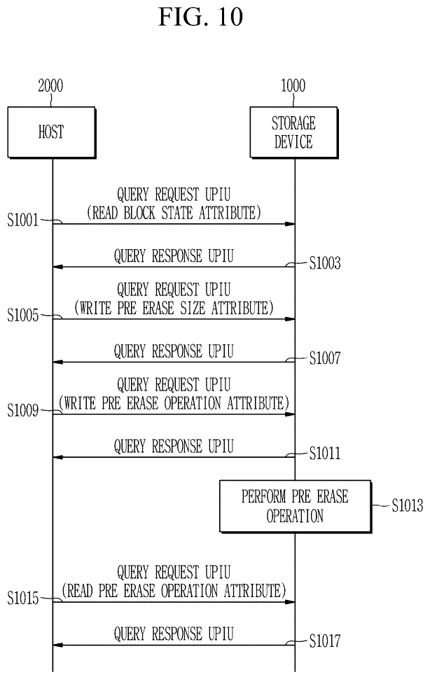

FIG. 10 is a diagram illustrating an example of a host providing a UPIU including a pre-erase operation attribute based on a block state attribute to a storage device.

Referring to FIG. 10, in S1001, the host 2000 may provide a query request UPIU requesting a read of a block status attribute to the storage device 1000. In some implementations, S1001 may be performed after S911 of FIG. 9.

In some implementations, in S1003, the storage device 1000 may provide a query response UPIU including block status attributes to the host 2000 in response to the query request UPIU. In some implementations, the block state attribute may include an identification number that identifies it as a block state attribute. In some implementations, the block status attribute may include erase block size information (BLK_ERS_SIZE), erase block level information (BLK_ERS_LEVEL), erase page size information (PG_ERS_SIZE), or pre-erase required information (PRE ERS_INFO).

In some implementations, in S1005, the host 2000 may determine the sizes of memory blocks to be pre-erased based on the block status attribute included in the query response UPIU, and provide a query request UPIU requesting writing of a pre-erasing size attribute regarding the sizes of memory blocks to be pre-erased to the storage device 1000. In some implementations, the pre-erasure size attribute may correspond to the pre-erasure size information (PE SIZE_INFO) described with reference to FIGS. 1 to 8.

In some implementations, in S1007, the storage device 1000 may store a pre-erase size attribute in response to a query request UPIU and provide a query response UPIU indicating that the pre-erase size attribute has been stored to the host 2000. In some implementations, the host 2000 can identify that the pre-erase size attribute is stored in the storage device 1000 based on the query response UPIU.

In some implementations, in S1009, the host 2000 may provide a query request UPIU to the storage device 1000 requesting a write of a pre-erase operation attribute requesting performance of a pre-erase operation. In some implementations, the pre-erase operation attribute may include an identification number of the pre-erase operation attribute and a third attribute value requesting the pre-erase operation. In some implementations, a query request UPIU requesting a pre-erase operation may correspond to a pre-erase command (CMD_PE) described with reference to FIGS. 1 to 8.

In some implementations, in S1011, the storage device 1000 may, in response to the query request UPIU, modify an attribute value included in the pre-erase operation attribute from a second attribute value to a third attribute value requesting the pre-erase operation, and provide a query response UPIU indicating that the pre-erase operation attribute has been stored to the host 2000.

In some implementations, in S1013, the storage device 1000 can perform a pre-erase operation based on a third attribute value included in the pre-erase operation attribute. In some implementations, the storage device 1000 may perform a pre-erase operation on invalid memory blocks among a plurality of memory blocks while performing the pre-erase operation. In some implementations, the storage device 1000 may perform a pre-erase operation on invalid memory blocks corresponding to a size to be pre-erased among invalid memory blocks based on a pre-erase size attribute. In some implementations, the storage device 1000 may, after performing a pre-erase operation, modify an attribute value included in a pre-erase operation attribute from a third attribute value to a second attribute value corresponding to completion of the pre-erase operation.

In some implementations, in S1015, the host 2000 may provide a query request UPIU requesting a read of a pre-erase operation attribute to the storage device 1000.

In some implementations, in S1017, the storage device 1000 may provide, to the host 2000, a query response UPIU including a pre-erase operation attribute of a second attribute value corresponding to completion of the pre-erase operation, in response to the query request UPIU. In some implementations, the host 2000 can identify that the pre-erase operation is complete based on the second attribute value included in the query response UPIU.

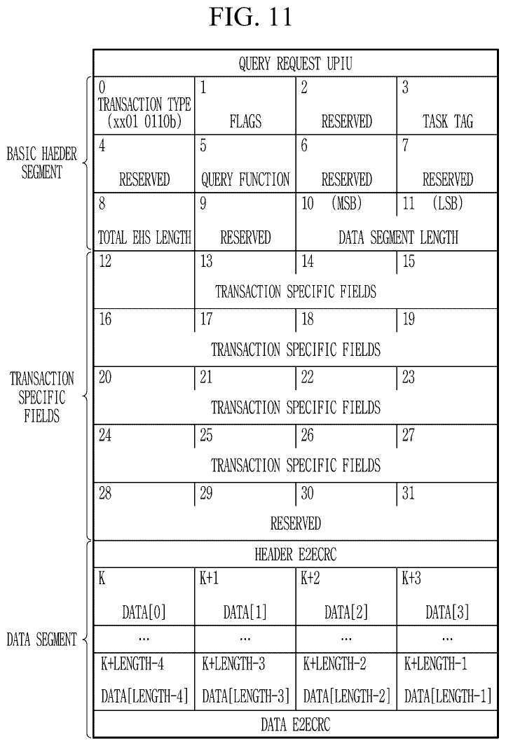

FIG. 11 is a diagram illustrating an example of a query request UPIU.

Referring to FIG. 11, a query request UPIU may include a basic header segment, transaction specific fields, and a data segment. In some implementations, each of the basic header segment, transaction specific fields, and data segment may include multiple fields.

In some implementations, the basic header segment may include fields zero through eleven (0-11). In some implementations, the zeroth field (0) may include a transaction type. In some implementations, the transaction type (TRANSACTION TYPE) of the query request may correspond to “xx01 0110b”.

In some implementations, the first field (1) may include flags (FLAGS). In some implementations, the flags may include values of “0” or “1” corresponding to true or false, on or off. In some implementations, flags may be used to enable or disable certain features, modes, or states.

In some implementations, the second field (2) may be a reserve field (RESERVED). In some implementations, the third field (3) may include a TASK TAG. In some implementations, the fourth field (4) may be a reserve field (RESERVED).

In some implementations, the fifth field (5) may include a query function (QUERY FUNCTION).

In some implementations, the sixth field (6) and the seventh field (7) may be reserved fields (RESERVED). In some implementations, the eighth field (8) may be a field indicating the total EHS (Extra Header Segment) length. In some implementations, the ninth field (9) may be a reserved field (RESERVED). In some implementations, the 10th field (10) and the 11th field (11) may be fields indicating a data segment length (DATA SEGMENT LENGTH). In some implementations, the 10th field (10) may be the Most Significant Bit (MSB) of the data segment length, and the 11th field (11) may be the Least Significant Bit (LSB) of the data segment length.

In some implementations, the transaction specific fields may include the twelfth through thirtieth fields (12-31). In some implementations, the 28th to 31st fields (28-31) may be spare fields. In some implementations, a data segment may include a header E2ECRC (End-to-End Cyclic Redundancy Code), k to k (k data segment length−1) fields (k˜k LENGTH−1), and data E2ECRC. In some implementations, the k-th to (k data segment length−1)-th fields (k˜k LENGTH−1) may include the 0-th to (data segment length−1)-th data (DATA[0]˜DATA[LENGTH−1]).

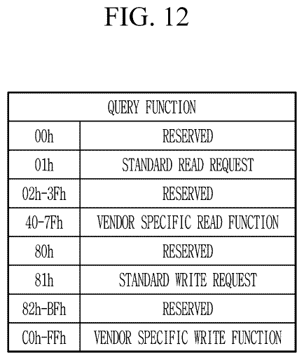

FIG. 12 is a diagram for illustrating a query function.

Referring to FIG. 12, a query function may be included in the fifth field (5) of a query request UPIU. In some implementations, the query function may be a function that indicates that the query request UPIU is a write request or a read request.

In some implementations, if the query function includes “01h”, the query request UPIU may be a standard lead request. In some implementations, if the query function includes “40-7Fh”, the query request UPIU may be a manufacturer-specific lead function.

In some implementations, if the query function includes “81h”, the query request UPIU may be a standard write request. In some implementations, if the query function includes “C0h-FFh”, the query request UPIU may be a manufacturer-specific write function.

In some implementations, among the values of the query function, “00h”, “02h-3Fh”, “80h”, and “82h-BFh” may be reserve values.

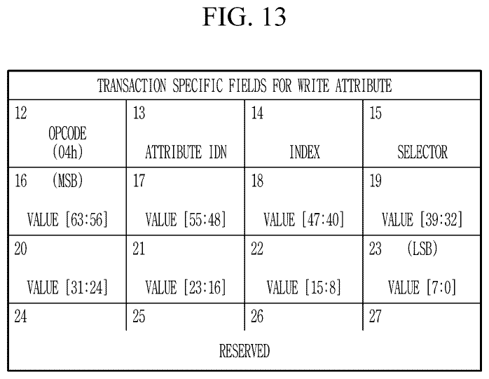

FIG. 13 is a diagram illustrating examples of transaction specific fields of a write property.

Referring to FIG. 13, the 12th to 27th fields (12-27) of the query request UPIU may be transaction specific fields for writing attributes. In some implementations, the operation code (OPCODE) for writing an attribute may be “04h”.

In some implementations, the 13th field (13) may be an ATTRIBUTE IDN. In some implementations, the 14th field (14) may be an index that can specifically identify an attribute. The 15th field (15) may be a SELECTOR that can identify the attribute more specifically.

In some implementations, the 16th to 23rd fields (16 to 23) may include attribute values (VALUE[7:0] to VALUE[63:56]). In some implementations, the 16th field (16) may be the MSB and the 23rd field (23) may be the LSB. In some implementations, the 24th to 27th fields (24-27) may be reserved fields (RESERVED).

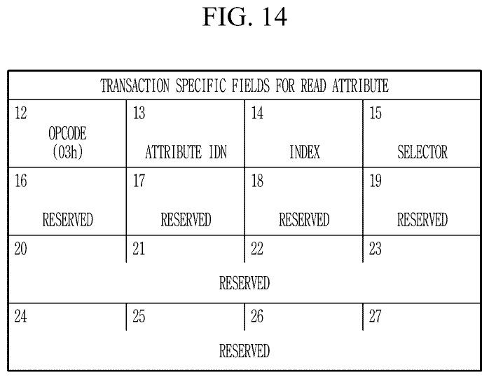

FIG. 14 is a diagram illustrating examples of transaction specific fields of a lead attribute.

Referring to FIG. 14, the 12th to 27th fields (12-27) of the query request UPIU may be transaction specific fields for leading attributes. In some implementations, the twelfth field (12) may be an operation code (OPCODE). In some implementations, the operation code (OPCODE) for leading the attribute may be “03h”.

In some implementations, the 13th field (13) may be an ATTRIBUTE IDN. In some implementations, the 14th field (14) may be an index that can specifically identify an attribute. The 15th field (15) may be a SELECTOR that can identify the attribute more specifically.

In some implementations, the 16th to 27th fields (16-27) may be spare fields.

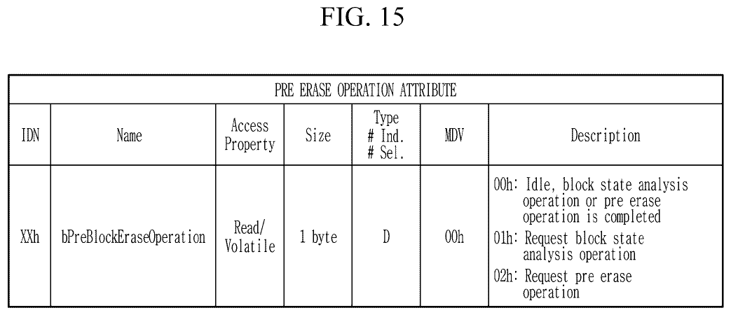

FIG. 15 is a diagram illustrating examples of pre-erasure operation properties.

In some implementations, the identification number (IDN) of the pre-erase operation attribute may be “XXh”. In some implementations, “XXh” can mean any value. In some implementations, the identification number (IDN) may be a number that identifies the attribute as a pre-erase operation attribute.

In some implementations, the Name of the pre-erase operation property may be “bPreBlockEraseOperation”.

In some implementations, the access property of the pre-erase operation property can be Read and Volatile. In some implementations, the Access Property of the pre-erase operation property can read and write the pre-erase operation property, and when the electronic system 50 is reset, the property value can be set to a default value.

In some implementations, the size of the pre-erase operation attribute may be 1 byte. In some implementations, the type of pre-erase operation may be device level (D). In some implementations, the Manufacturer Default Value (MDV) of the pre-erase operation attribute may be “00h”.

In some implementations, a pre-erase operation attribute including an attribute value corresponding to “00h” may be an attribute indicating that the storage device 1000 is in an idle state or that a block state analysis operation or a pre-erase operation has been completed. In some implementations, the attribute value corresponding to “00h” may correspond to the second attribute value described with reference to FIGS. 9 and 10.

In some implementations, a pre-erase operation attribute including an attribute value corresponding to “01h” may be an attribute for which the host 2000 requests a block state analysis operation to the storage device 1000. In some implementations, the attribute value corresponding to “01h” may correspond to the first attribute value described with reference to FIG. 9.

In some implementations, a pre-erase operation attribute including an attribute value corresponding to “02h” may be an attribute by which the host 2000 requests a pre-erase operation to the storage device 1000. In some implementations, the attribute value corresponding to “02h” may correspond to the third attribute value described with reference to FIG. 10.

In some implementations, the storage device 1000 may perform a block state analysis operation or a pre-erase operation according to a pre-erase operation attribute including an attribute value corresponding to “01h” or “02h”, and then modify the attribute value from “01h” or “02h” to “00h”.

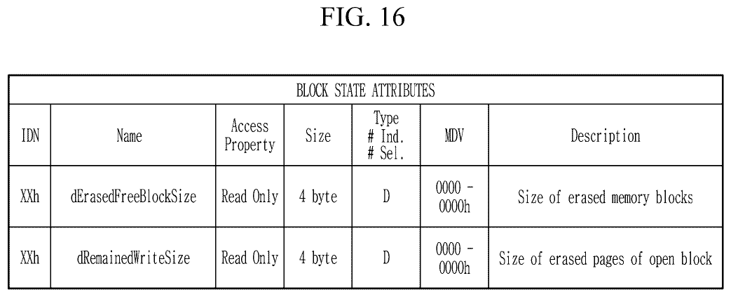

FIG. 16 is a diagram illustrating examples of block state properties.

Referring to FIG. 16, the block state attribute may correspond to the block state information 1221 described with reference to FIGS. 1 to 8. In some implementations, the block status attribute may include an erase block size attribute or an erase page size attribute.

In some implementations, the Name of the erased block size property may be “dErasedFreeBlockSize”. In some implementations, the erase block size attribute may include a value relating to the size of erased memory blocks. In some implementations, the erase block size attribute may correspond to the erase block size information (BLK_ERS_SIZE) described with reference to FIGS. 1 to 8.

In some implementations, the identification number (IDN) of the erase block size attribute may be “XXh”. In some implementations, the Access Property of the erase block size attribute may be Read Only. In some implementations, the access property of the erase block size attribute may allow only reads to the erase block size attribute, and may prohibit writes by the host 2000 to the erase block size attribute.

In some implementations, the size of the erase block size attribute may be 4 bytes. In some implementations, the type of the erase block size attribute may be device level (D). In some implementations, the manufacturer default value (MDV) of the erase block size attribute may be “0000-0000h”.

In some implementations, the Name of the erased page size property may be “dRemainedWriteSize”. In some implementations, the erased page size attribute may include a value relating to the size of erased pages of an open block. In some implementations, the erase page size attribute may correspond to the erase page size information (PG_ERS_SIZE) described with reference to FIGS. 1 to 8.

In some implementations, the identification number (IDN) of the erase page size attribute may be “XXh”. In some implementations, the Access Property of the Erased Page Size attribute may be Read Only. In some implementations, the access property of the erase page size attribute may allow only reads to the erase page size attribute, and may prohibit writes by the host 2000 to the erase page size attribute.

In some implementations, the size of the erase page size attribute may be 4 bytes. In some implementations, the type of the erase page size attribute may be device level (D). In some implementations, the manufacturer default value (MDV) of the erase page size attribute may be “0000-0000h”.

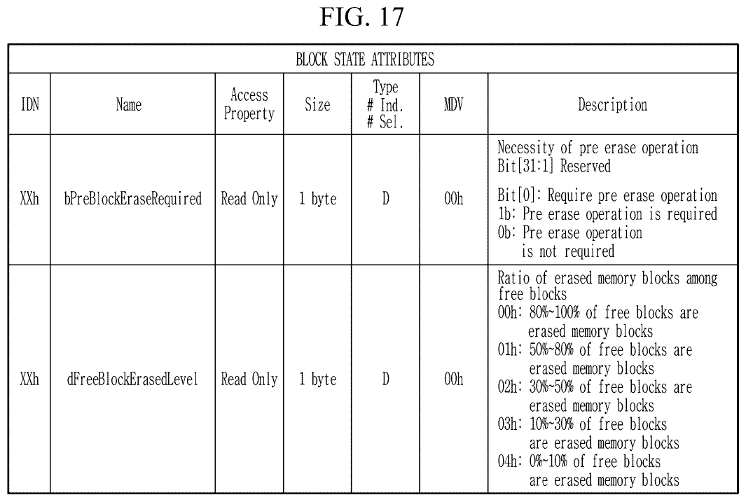

FIG. 17 is a diagram illustrating examples of of block state properties.

Referring to FIG. 17, the block state attribute may correspond to the block state information 1221 described with reference to FIGS. 1 to 8. Block status attributes may include pre-erase required attributes or erase block level attributes.

In some implementations, the Name of the pre-erase required property may be “bPreBlockEraseRequired”. In some implementations, the pre-erase required attribute may include a value indicating whether a pre-erase operation is required. In some implementations, the pre-erase required attribute may correspond to the pre-erase required information (PRE ERS_INFO) described with reference to FIGS. 1 to 8.

In some implementations, the pre-erase required attribute may include bits 0 through 31 (Bit[0], Bit[31:1]). In some implementations, the zeroth bit (Bit[0]) may contain a value indicating whether a pre-erase operation is required. In some implementations, a value of Bit[0] of “1” may indicate that a pre-erase operation is required. In some implementations, a value of Bit[0] of “0” may mean that a pre-erase operation is unnecessary. In some implementations, the first to 31st bits (Bit[31:1]) may be spare bits.

In some implementations, the identification number (IDN) of the attribute requiring pre-erasure may be “XXh”. In some implementations, the Access Property of the pre-erase required property may be Read Only. In some implementations, the access property of the pre-erase required property may allow only reads to the pre-erase required property, and may prohibit writes by the host 2000 to the pre-erase required property.

In some implementations, the size of the pre-erase required attribute may be 1 byte. In some implementations, the type of the pre-clearing required attribute may be device level (D). In some implementations, the manufacturer default value (MDV) of the pre-clear required attribute may be “00h”.

In some implementations, the Name of the erased block level attribute may be “dFreeBlockErasedLevel”. In some implementations, the erased block level attribute may include a value relating to the ratio of erased memory blocks among free blocks. In some implementations, the erase block level attribute may correspond to the erase block level information (BLK_ERS_LEVEL) described with reference to FIGS. 1 to 8.

In some implementations, an erased block level attribute including an attribute value corresponding to “00h” may be an attribute indicating that more than 80% and less than or equal to 100% of free blocks are erased memory blocks.

In some implementations, an erased block level attribute including an attribute value corresponding to “01h” may be an attribute indicating that more than 50% and less than or equal to 80% of free blocks are erased memory blocks.

In some implementations, an erased block level attribute including an attribute value corresponding to “02h” may be an attribute indicating that more than 30% and less than or equal to 50% of free blocks are erased memory blocks.

In some implementations, an erased block level attribute including an attribute value corresponding to “03h” may be an attribute indicating that more than 10% and less than or equal to 30% of free blocks are erased memory blocks.

In some implementations, an erased block level attribute including an attribute value corresponding to “04h” may be an attribute indicating that 0% or more and 10% or less of free blocks are erased memory blocks.

In some implementations, the identification number (IDN) of the erase block level attribute may be “XXh”. In some implementations, the Access Property of the erase block level attribute may be Read Only. In some implementations, the access property of the erase block level property may allow only reads to the erase block level property, and may prohibit writes by the host 2000 to the erase block level property.

In some implementations, the size of the erase block level attribute may be 1 byte. In some implementations, the type of the erase block level attribute may be device level (D). In some implementations, the manufacturer default value (MDV) of the erase block level attribute may be “00h”.

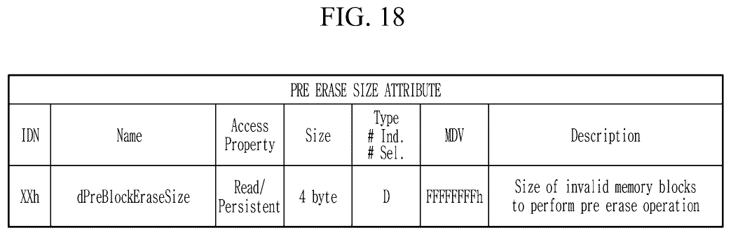

FIG. 18 is a diagram illustrating an example of pre-erasure size properties. Referring to FIG. 18, the name of the pre-erase size property can be “dPreBlockEraseSize”. The pre-erase size attribute may contain a value regarding the size of invalid memory blocks on which pre-erase operations are to be performed. In some implementations, the pre-erasure size attribute may correspond to the pre-erasure size information (PE SIZE_INFO) described with reference to FIGS. 1 to 8.

In some implementations, the identification number (IDN) of the pre-erasure size attribute may be “XXh”. In some implementations, the access properties of the pre-erase size attribute can be Read and Persistent. In some implementations, the access property of the pre-erase size attribute can read and write the pre-erase size attribute, and the value set as the pre-erase size can be maintained even if the electronic system 50 is reset.

In some implementations, the size of the pre-erase size attribute may be 4 bytes. In some implementations, the type of the pre-erase size attribute may be device level (D). In some implementations, the manufacturer default value (MDV) of the pre-erase size attribute may be “FFFFFFFFh”.

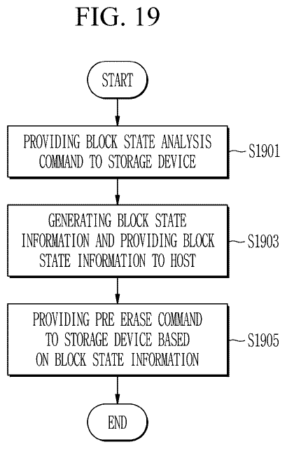

FIG. 19 is a flowchart illustrating an example of operation of an electronic system.

Referring to FIG. 19, in S1901, the host 2000 may provide a block status analysis command to the storage device 1000. In some implementations, the host 2000 may identify whether the storage device 1000 is idle, and if the storage device 1000 is idle, provide a block state analysis command to the storage device 1000. In some implementations, the block state analysis command may respond to a query request UPIU including a pre-erase operation attribute of an attribute value requesting block state analysis.

In S1903, the storage device 1000 can generate block status information and provide the block status information to the host 2000. In some implementations, the block status information may include erase block size information regarding the size of erased memory blocks, erase block level information regarding the ratio of erased memory blocks among free blocks, erase page size information regarding the size of erased pages included in an open block, or pre-erase need information regarding whether a pre-erase operation is required.

In S1905, the host 2000 may provide a pre-erase command to the storage device 1000 based on block status information. In some implementations, the host 2000 may provide a pre-erase command to the storage device 2000 if the size of the erased memory blocks is less than the size of the data to be provided to the storage device 1000 among the data stored in the host memory. In some implementations, the pre-erase command may correspond to a query request UPIU including a pre-erase operation attribute of an attribute value requesting the pre-erase operation. In some implementations, the storage device 1000 may perform a pre-erase operation on invalid memory blocks among a plurality of memory blocks in response to a pre-erase command received from the host 2000.

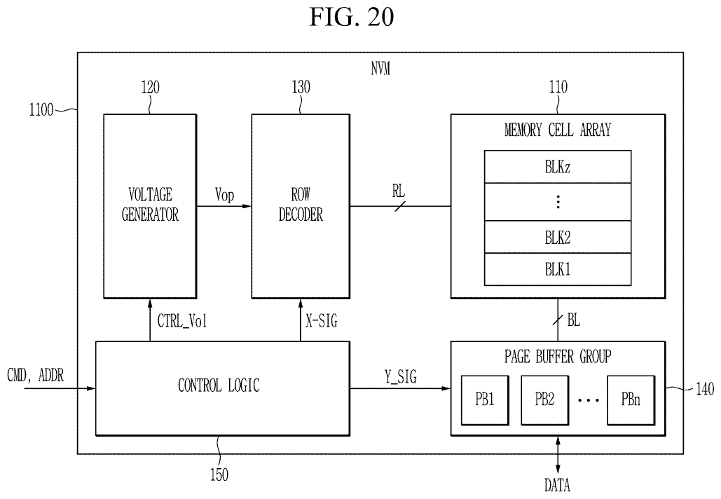

FIG. 20 is a diagram illustrating an example of a nonvolatile memory device. Referring to FIG. 20, a nonvolatile memory device 1100 may include a memory cell array 110, a voltage generator 120, a row decoder 130, a page buffer group 140, and control logic 150.

The memory cell array 110 may include a plurality of memory blocks (BLK1 to BLKz). Multiple memory blocks (BLK1 to BLKz) can be connected to a row decoder 130 through row lines (RL). Multiple memory blocks (BLK1 to BLKz) can be connected to a page buffer group 140 through bit lines (BL). Each of the multiple memory blocks (BLK1 to BLKz) can include multiple memory cells. In some implementations, the plurality of memory cells may be non-volatile memory cells. In some implementations, the plurality of memory blocks (BLK1 to BLKz) may include invalid memory blocks in which invalid data is stored, valid memory blocks in which valid data is stored, off blocks in which some data is stored, and erased memory blocks in which no data is stored.

The voltage generator 120 can generate operating voltages (Vop) using an external power voltage supplied to a nonvolatile memory device 1100. The voltage generator 120 can operate in response to the control of the control logic 150.

In some implementations, the voltage generator 120 can generate operating voltages (Vop) used for program operations, read operations, and erase operations. For example, the voltage generator 120 can generate a program voltage, a pass voltage, a read voltage, and an erase voltage. Operating voltages (Vop) can be supplied to the memory cell array 110 by the row decoder 130.

The row decoder 130 can be connected to the memory cell array 110 via row lines (RL). Row lines (RL) may include string select lines, word lines, and ground select lines.

The row decoder 130 can operate in response to the control of the control logic 150. The row decoder 130 can receive a row signal (X_SIG) from the control logic 150. In some implementations, the row decoder 130 may select at least one word line among a plurality of word lines based on a row signal (X_SIG) and apply operating voltages (Vop) provided from a voltage generator 120 to at least one word line.

In some implementations, the row decoder 130 may apply a program voltage to a selected word line among a plurality of word lines during a program operation and apply a pass voltage at a level lower than the program voltage to unselected word lines. The row decoder 130 can apply a verification voltage to a selected word line during a program verification operation and apply a verification pass voltage at a level higher than the verification voltage to unselected word lines.

The row decoder 130 can apply a read voltage to a selected word line during a read operation and apply a read pass voltage at a level higher than the read voltage to unselected word lines.

A page buffer group 140 may include multiple page buffers (PB1 to PBn). A plurality of page buffers (PB1 to PBn) can be respectively connected to a plurality of memory cells included in a memory cell array 110 through bit lines (BL). Multiple page buffers (PB1 to PBn) can operate in response to the control of the control logic 150.

In some implementations, multiple page buffers (PB1 to PBn) can receive data (DATA) from the storage controller 1200. A plurality of page buffers (PB1 to PBn) can select at least one bit line among the bit lines (BL) based on a column signal (Y_SIG) received from the control logic 150.

In some implementations, a plurality of page buffers (PB1 to PBn) can transmit data received from a storage controller 1200 to a plurality of memory cells of a memory cell array 110 through bit lines (BL) during a program operation. Multiple memory cells can be programmed according to received data. Multiple page buffers (PB1 to PBn) can sense data stored in multiple memory cells through bit lines (BL) during program verification operation.

Multiple page buffers (PB1 to PBn) can sense data stored in memory cells through bit lines (BL) during a read operation and store the sensed data in multiple page buffers (PB1 to PBn).

The control logic 150 can be connected to a voltage generator 120, a row decoder 130, and a page buffer group 140.

The control logic 150 can control the overall operation of the nonvolatile memory device 1100. The control logic 150 can control the voltage generator 120, the row decoder 130, and the page buffer group 140 to perform an operation corresponding to the command in response to a command received from the storage controller 1200.

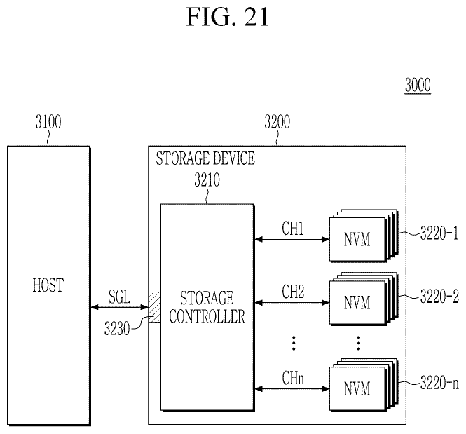

FIG. 21 is diagram illustrating an example of a storage system. Referring to FIG. 21, a storage system 3000 may include a host 3100 and a storage device 3200.

In some implementations, the storage device 3200 may communicate with the host 3100 using an interface such as Non-Volatile Memory express (NVMe), Peripheral Component Interconnect express (PCIe), Universal Serial Bus (USB), Double Data Rate (DDR), Low Power DDR (LPDDR), Serial Advanced Technology Attachment (SATA), Small Computer System Interface (SCSI), etc.

In some implementations, the storage device 3200 may include a storage controller 3210 and a plurality of non-volatile memory devices 3220-1 to 3220-n.

In some implementations, the storage controller 3210 may be connected to a plurality of nonvolatile memory devices 3220-1 to 3220-n through a plurality of channels (CH1 to CHn).

In some implementations, the storage controller 3210 can transmit and receive a signal (SGL) with the host 3100 through a signal connector 3230. In some implementations, the signal (SGL) may include a command, an address, and data, etc. The storage controller 3210 can store data in a plurality of nonvolatile memory devices 3220-1 to 3220-n or read data stored in a plurality of nonvolatile memory devices 3220-1 to 3220-n according to a command from the host 3100.

In some implementations, the storage controller 3210 may include a pre-erase management module 1211 of FIG. 1. In some implementations, the pre-erase management module 1211 may generate block status information in response to a block status analysis command received from the host 3100 and provide the block status information to the host 3100. In some implementations, the pre-erase management module 1211 may control a plurality of nonvolatile memory devices 3220-1 to 3220-n to perform a pre-erase operation on invalid memory blocks among a plurality of memory blocks in response to a pre-erase command received from the host 3100.

In some implementations, a plurality of nonvolatile memory devices 3220-1 to 3220-n can be used as storage media of the storage device 3200. In some implementations, each of the plurality of nonvolatile memory devices (323-1, 323-2, . . . , 323-n) may include a memory cell array formed in a three-dimensional structure on a substrate. A memory cell array may include a plurality of memory cells that store data.

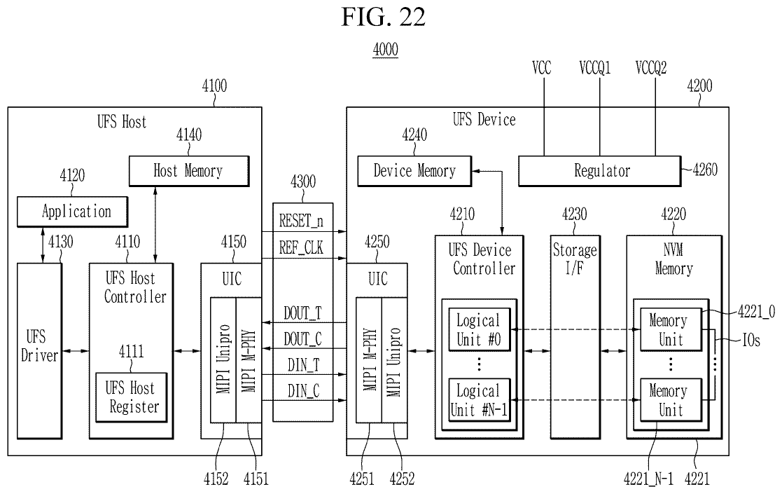

FIG. 22 is a diagram illustrating an example of a UFS (Universal Flash Storage) system. Referring to FIG. 22, a UFS system 4000 may include a UFS host 4100, a UFS device 4200, and a UFS interface 4300.

In some implementations, a UFS host 4100 may include a UFS host controller 4110, an application 4120, a UFS driver 4130, host memory 4140, and a UFS interconnect (UIC) layer 4150.

In some implementations, a UFS device 4200 may include a UFS device controller 4210, non-volatile memory 4220, a storage interface 4230, device memory 4240, a UIC layer 4250, and a regulator 4260. The nonvolatile memory 4220 may be composed of a plurality of memory units 4221_0 to 4221_N-1, and the plurality of memory units 4221_0 to 4221_N-1 may include V-NAND flash memory having a 2D structure or a 3D structure, but may also include other types of nonvolatile memory such as PRAM and/or RRAM. The UFS device controller 4210 and the non-volatile memory 4220 may be connected to each other through a storage interface 4230. The storage interface 4230 may be implemented to comply with standard protocols such as Toggle or ONFI.

In some implementations, the plurality of memory units 4221_0 to 4221_N-1 may be implemented as a plurality of non-volatile memory devices. Each of the plurality of memory units 4221_0 to 4221_N-1 may include a memory cell array and a control circuit that controls operations for the memory cell array.

The application 4120 may be a program that desires to communicate with the UFS device 4200 to utilize the functions of the UFS device 4200. An application 4120 can send an input-output request (IOR) to a UFS driver 4130 for input/output to a UFS device 4200. In some implementations, an input/output request (IOR) may mean a request to read data, a request to write data, and/or a request to discard data.

In some implementations, the UFS driver 4130 may manage the UFS host controller 4110 via UFS-HCl (host controller interface). The UFS driver 4130 can convert input/output requests generated by the application 4120 into UFS commands defined by the UFS standard and transmit the converted UFS commands to the UFS host controller 4110. A single I/O request can be translated into multiple UFS commands. UFS commands can be commands defined primarily by the SCSI standard, but can also be commands specific to the UFS standard.

The UFS host controller 4110 can transmit the UFS command converted by the UFS driver 4130 to the UIC layer 4250 of the UFS device 4200 through the UIC layer 4150 and the UFS interface 4300. In this process, the UFS host register 4111 of the UFS host controller 4110 can serve as a command queue (CQ).

In some implementations, the UFS host controller 4110 may provide a query request UPIU including a pre-erase operation attribute of an attribute value requesting block state analysis to the UFS device 4200. In some implementations, the UFS host controller 4110 may provide a query request UPIU requesting block status attributes generated in response to a block status analysis request to the UFS device 4200. In some implementations, the UFS host controller 4110 may provide a query request UPIU to the UFS device 4200 that includes a pre-erase operation attribute of an attribute value requesting a pre-erase operation.

In some implementations, the UIC layer 4150 on the UFS host 4100 side may include MIPI M-PHY 4151 and MIPI UniPro 4152, and the UIC layer 4250 on the UFS device 4200 side may also include MIPI M-PHY 4251 and MIPI UniPro 4252.

In some implementations, the UFS interface 4300 may include a line transmitting a reference clock (REF_CLK), a line transmitting a hardware reset signal (RESET_n) for the UFS device 4200, a pair of lines transmitting a differential input signal pair (DIN_t and DIN_c), and a pair of lines transmitting a differential output signal pair (DOUT_t and DOUT_c).

In some implementations, the UFS interface 4300 may support multiple lanes, and each lane may be implemented as a differential pair. For example, a UFS interface 4300 may include one or more receive lanes and one or more transmit lanes. The receiving lane and the transmitting lane can transmit data in a serial communication manner, and full-duplex communication between the UFS host 4100 and the UFS device 4200 can be possible due to the structure in which the receiving lane and the transmitting lane are separated.

In some implementations, the UFS device controller 4210 of the UFS device 4200 can control the overall operation of the UFS device 4200. The UFS device controller 4210 can manage non-volatile memory 4220 through a logical unit (LU) 4211, which is a logical data storage unit. The number of LUs (2211) can be 4 or 8, but is not limited thereto. The UFS device controller 4210 may include a flash translation layer (FTL) and may convert a logical address transmitted from a UFS host 4100 into a physical address using address mapping information of the FTL. In a UFS system 4000, a logical block for storing user data can have a size within a predetermined range. For example, the minimum size of a logical block can be set to 4Kbytes.

In some implementations, when a command from a UFS host 4100 is input to a UFS device 4200 through a UIC layer 4250, the UFS device controller 4210 may perform an operation according to the input command, and when the operation is completed, transmit a completion response to the UFS host 4100.

In some implementations, when a UFS host 4100 wants to store user data in a UFS device 4200, the UFS host 4100 may transmit a data storage command to the UFS device 4200. When a response indicating that user data is ready to be transferred (ready-to-transfer) is received from the UFS device 4200, the UFS host 4100 can transfer the user data to the UFS device 4200. The UFS device controller 4210 can temporarily store the received user data in the device memory 4240 and store the user data temporarily stored in the device memory 4240 in a selected location of the non-volatile memory 4220 based on the address mapping information of the FTL.

In some implementations, when a UFS host 4100 wishes to read user data stored in a UFS device 4200, the UFS host 4100 may transmit a data read command to the UFS device 4200. The UFS device controller 4210 that receives the command can read user data from the non-volatile memory 4220 based on the data read command and temporarily store the read user data in the device memory 4240. During this read process, the UFS device controller 4210 can detect and correct errors in the read user data using a built-in ECC (error correction code) engine. For example, the ECC engine can generate parity bits for write data to be written to the nonvolatile memory 4220, and the parity bits thus generated can be stored in the nonvolatile memory 4220 together with the write data. When reading data from a nonvolatile memory 4220, the ECC engine can correct errors in the read data using parity bits read from the nonvolatile memory 4220 together with the read data, and output the read data with the errors corrected.

In some implementations, the UFS device controller 4210 may generate a block state attribute in response to a query request UPIU including a pre-erase operation attribute of an attribute value requesting block state analysis received from a UFS host 4100. In some implementations, the UFS device controller 4210 may provide block status attributes to the UFS host 4100 in response to a query request UPIU requesting block status attributes received from the UFS host 4100. In some implementations, the UFS device controller 4210 may perform a pre-erase operation on invalid memory blocks in response to a query request UPIU including a pre-erase operation attribute in an attribute value requesting a pre-erase operation received from a UFS host 4100.

In some implementations, the UFS host 4100 may sequentially store commands to be transmitted to the UFS device 4200 in a UFS host register 4111 that may function as a command queue, and transmit the commands to the UFS device 4200 in the sequential order. At this time, the UFS host 4100 can transmit the next command waiting in the command queue to the UFS device 4200 even if the previously transmitted command is still being processed by the UFS device 4200, that is, even before receiving a notification that the previously transmitted command has been completed by the UFS device 4200, and accordingly, the UFS device 4200 can also receive the next command from the UFS host 4100 even while processing the previously transmitted command. Additionally, the command queue can be implemented as a circular queue type that indicates the start and end of the command sequence stored in the queue through a head pointer and a tail pointer, respectively.

In some implementations, VCC, VCCQ, VCCQ2, etc. may be input as power voltages to the UFS device 4200. VCC is the main power voltage for the UFS device 4200 and can have a value of 2.4 to 3.6 V. VCCQ is a power supply voltage for supplying a low range of voltage, mainly for the UFS device controller 4210. It can have a value of 1.14 to 1.26 V. VCCQ2 is a power supply voltage that supplies a voltage range lower than VCC but higher than VCCQ, mainly for input/output interfaces such as MIPI M-PHY 4251, and can have a value of 1.7 to 1.95 V. Power voltages can be supplied to each component of the UFS device 4200 through a regulator 4260. The regulator 4260 may be implemented as a set of unit regulators each connected to a different one of the aforementioned power supply voltages.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

Although examples have been described in detail above, the scope of the present disclosure is not limited thereto, and various modifications and improvements made by those skilled in the art also fall within the scope of the present disclosure.

What is claimed is:

1. An electronic system comprising:
a host configured to output a block status analysis command; and
a storage device configured to, in response to the block status analysis command, generate block status information of at least one memory block of a plurality of memory blocks of a nonvolatile memory device, and provide the block status information to the host,
wherein the host is configured to, based on the block status information, provide the storage device with a pre-erase command instructing a pre-erase operation for invalid memory blocks of the plurality of memory blocks, the invalid memory blocks storing invalid data.

2. The electronic system of claim 1, wherein the block status information comprises information about a size of one or more erased memory blocks of the plurality of memory blocks.

3. The electronic system of claim 2, wherein the host is configured to provide the pre-erase command to the storage device based on the size of the one or more erased memory blocks being less than a threshold size.

4. The electronic system of claim 3, wherein the host includes a host memory, and
wherein the threshold size is based on a size of data being provided to the storage device, from among data stored in the host memory.

5. The electronic system of claim 1, wherein one or more open blocks each comprise erased pages and programmed pages, and
wherein the block status information comprises a size of the erased pages of the one or more open blocks.

6. The electronic system of claim 5, wherein the host includes a host memory; and
wherein the host is configured to provide the pre-erase command to the storage device based on a size of first data among data stored in the host memory being larger than the size of the erased pages, the first data being provided to the storage device.

7. The electronic system of claim 1, wherein the block status information comprises an indication for the host to instruct the pre-erase operation, and
wherein the storage device is configured to generate the indication based on a size of one or more erased memory blocks of the plurality of memory blocks.

8. The electronic system of claim 1, wherein the block status information comprises information about a proportion of erased memory blocks among a plurality of free blocks of the plurality of memory blocks, wherein the plurality of free blocks includes the invalid memory blocks.

9. The electronic system of claim 8, wherein the host is configured to provide the pre-erase command to the storage device based on the proportion being higher than a threshold level.

10. The electronic system of claim 1, wherein:
the host is configured to:
determine a size of memory blocks to be pre-erased in the pre-erase operation based on the block status information, and
provide an indication of the size of the memory blocks to be pre-erased to the storage device; and
wherein the storage device is configured to perform the pre-erase operation on the invalid memory blocks based on the indication of the size of the memory blocks to be pre-erased.

11. A method of operation of a storage device, the method comprising:
receiving, from a host, a first universal flash storage (UFS) protocol information unit (UPIU) including:
an identification number of a pre-erase operation attribute, and
a first attribute value requesting block status analysis;
generating, based on the first attribute value, a block status attribute based on one or more erased memory blocks of a plurality of memory blocks of a nonvolatile memory device;
receiving, from the host, a second UPIU requesting the block status attribute;
providing the block status attribute to the host in response to the second UPIU;
receiving, from the host, a third UPIU including:
the identification number of the pre-erase operation attribute, and
a second attribute value requesting a pre-erase operation; and
performing the pre-erase operation on invalid memory blocks of the plurality of memory blocks based on the second attribute value.

12. The method of claim 11, wherein the block status attribute comprises information about a size of the one or more erased memory blocks of the plurality of memory blocks.

13. The method of claim 11, wherein the block status attribute comprises an indication for the host to instruct the pre-erase operation, and wherein generating the block status attribute comprises:
comparing a size of the one or more erased memory blocks, of the plurality of memory blocks, with a threshold size, and
generating the block status attribute based on the comparison.

14. The method of claim 11, wherein the block status attribute comprises information about a proportion of the one or more erased memory blocks among a plurality of free blocks of the plurality of memory blocks, wherein the plurality of free blocks includes the invalid memory blocks.

15. The method of claim 11, further comprising:
receiving, from the host, a fourth UPIU including:
an identification number of a pre-erase size attribute, and
an indication of a size of memory blocks to be pre-erased in the pre-erase operation,
wherein performance of the pre-erase operation is based on the indication of the size of memory blocks to be pre-erased.

16. A method of operation of a host, the method comprising:
providing, to a storage device, a first universal flash storage (UFS) protocol information unit (UPIU) including:
an identification number of a pre-erase operation attribute, and
a first attribute value requesting block status analysis;
providing, to the storage device, a second UPIU requesting a block state attribute;
receiving the block state attribute from the storage device as a response to the second UPIU, wherein the block state attribute is based on one or more erased memory blocks of a plurality of memory blocks of the storage device; and
based on the block state attribute, providing, to the storage device, a third UPIU comprising:
the identification number of the pre-erase operation attribute, and
a second attribute value requesting that the storage device perform a pre-erase operation on invalid memory blocks of the plurality of memory blocks.

17. The method of claim 16, wherein the block state attribute comprises a size of the one or more erased memory blocks of the plurality of memory blocks, and
wherein providing the third UPIU to the storage device is based on a result of comparing the size of the one or more erased memory blocks with a threshold size.

18. The method of claim 16, wherein the block state attribute comprises an indication for the host to instruct the pre-erase operation.

19. The method of claim 16, wherein the block state attribute comprises a size of erased pages of one or more open blocks, wherein the one or more open blocks each comprise erased pages and programmed pages, and
wherein providing the third UPIU to the storage device is performed based on a size of data to be provided to the storage device, from among data stored in a host memory of the host, is larger than the size of the erased pages of the one or more open blocks.

20. The method of claim 16, comprising:
determining a size of memory blocks to be pre-erased in the pre-erase operation based on the block state attribute after receiving the block state attribute as a response to the second UPIU; and
providing, to the storage device, a fourth UPIU that includes:
an identification number of a pre-erase size attribute, and
an indication of the size of memory blocks to be pre-erased in the pre-erase operation.
